(19) United States
(12) Patent Application Publication
(10) Pub. No.: US 2024/0073705 A1
(43) Pub. Date: Feb. 29, 2024

(54) MU-MIMO ASSISTANCE INFORMATION

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US); Alexei Yurievitch GOROKHOV, San Diego, CA (US); Kai TANG, San Diego, CA (US); Aamod KHANDEKAR, San Diego, CA (US)

(21) Appl. No.: 17/822,407

(22) Filed: Aug. 25, 2022

(51) Int. Cl. H04W 24/02; H04B 7/0452; H04B 7/06

(52) U.S. Cl. CPC H04W 24/02; H04B 7/0452; H04B 7/0626

(57) ABSTRACT

A network node may be configured to transmit a first indication of MIMO assistance information for a UE, where the MIMO assistance information is associated with at least one of a SU-MIMO configuration or a MU-MIMO configuration. The UE may receive the first indication of MIMO assistance information from a network node, perform at least one of an inter-layer IC operation, a CSI reporting operation, or an SRS antenna port switching operation based on at least one of the SU-MIMO configuration or the MU-MIMO configuration, and transmit information associated with at least one of the CSI reporting operation or the SRS antenna port switching operation based on at least one of the SU-MIMO configuration or the MU-MIMO configuration. The network node may obtain the information associated with at least one of a CSI reporting operation or an SRS antenna port switching operation.

### TECHNICAL FIELD

The present disclosure relates generally to communication systems, and more particularly, to a method of wireless communication including multiple-user multi-input multi-output (MU-MIMO) assistance information for network entities.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE) configured to receive a first indication of multiple-input multiple-out (MIMO) assistance information from a network node, where the MIMO assistance information is associated with at least one of a single-user MIMO (SU-MIMO) configuration or a multiple-user MIMO (MU-MIMO) configuration, perform at least one of an inter-layer interference cancelation (IC) operation, a channel state information (CSI) reporting operation, or a sounding reference signal (SRS) antenna port switching operation based on at least one of the SU-MIMO configuration or the MU-MIMO configuration, and transmit information associated with at least one of the CSI reporting operation or the SRS antenna port switching operation based on at least one of the SU-MIMO configuration or the MU-MIMO configuration.

In an aspect of the disclosure, a method, a computer-readable medium, and an apparatus are provided. The apparatus may include a network node configured to transmit a first indication of MIMO assistance information for a UE, where the MIMO assistance information is associated with at least one of a SU-MIMO configuration or a MU-MIMO configuration, and obtain information associated with at least one of a CSI reporting operation or an SRS antenna port switching operation based on at least one of the SU-MIMO configuration or the MU-MIMO configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 includes diagrams illustrating wireless communication including multiple user equipments (UEs) in multi-input multi-output (MIMO) operation.

FIG. 5 is a call-flow diagram of a method of wireless communication.

FIG. 6 is a flowchart of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a diagram illustrating an example of a hardware implementation for an example apparatus and/or network entity.

FIG. 11 is a diagram illustrating an example of a hardware implementation for an example network entity.

FIG. 12 is a diagram illustrating an example of a hardware implementation for an example network entity.

### DETAILED DESCRIPTION

In a multiple-user multi-input multi-output (MU-MIMO) scenarios, more than one user equipments (UEs) may be paired to share the same time-frequency resources, and the paired UEs may be associated with respective layers. The network node may not provide information related to the MU-MIMO configurations, and the UEs may not be aware of other UEs that may affect the interference and spectral efficiency of the UE operating in MU-MIMO. In some aspects of the current disclosure, the network node may provide MU-MIMO assistance information associated with the MU-MIMO configuration to the UE, and the UE may perform inter-layer interference cancelation based on the MU-MIMO assistance information.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment nanufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

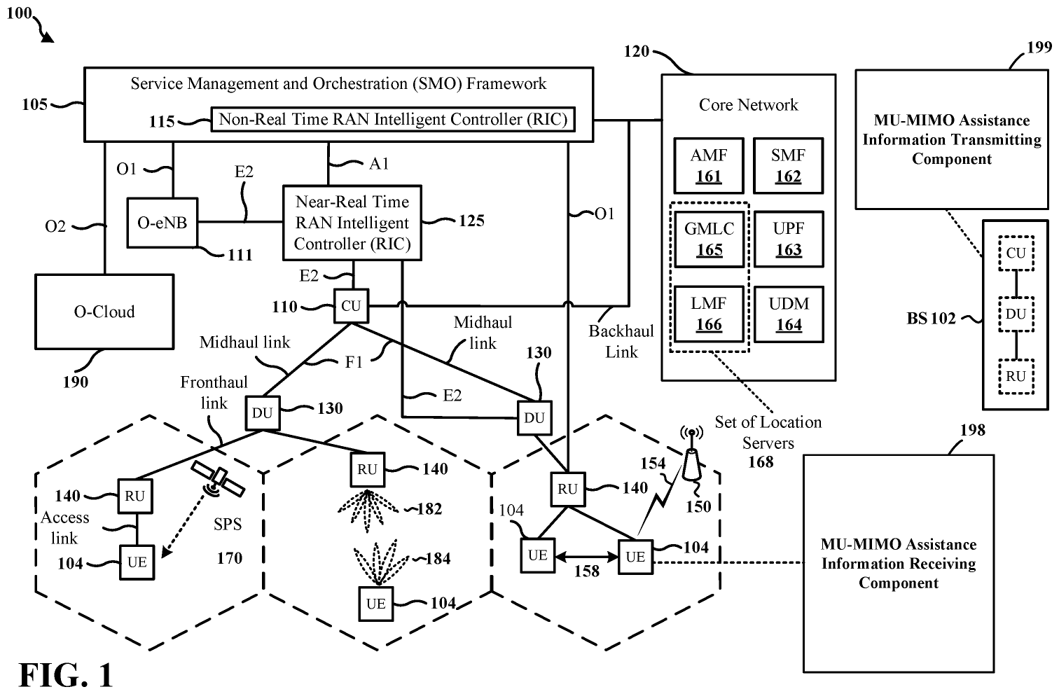

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be include a MU-MIMO assistance information receiving component 198 configured to receive a first indication of MIMO assistance information from a network node, where the MIMO assistance information is associated with at least one of a SU-MIMO configuration or a MU-MIMO configuration, perform at least one of an inter-layer IC operation, a CSI reporting operation, or an SRS antenna port switching operation based on at least one of the SU-MIMO configuration or the MU-MIMO configuration, and transmit information associated with at least one of the CSI reporting operation or the SRS antenna port switching operation based on at least one of the SU-MIMO configuration or the MU-MIMO configuration. In certain aspects, the base station 102 may include a MU-MIMO assistance information transmitting component 199 configured to transmit a first indication of MIMO assistance information for a UE, where the MIMO assistance information is associated with at least one of a SU-MIMO configuration or a MU-MIMO configuration, and obtain information associated with at least one of a CSI reporting operation or an SRS antenna port switching operation based on at least one of the SU-MIMO configuration or the MU-MIMO configuration. Although the following description may be focused on 5G NR, the concepts described herein may be applicable to other similar areas, such as LTE, LTE-A, CDMA, GSM, and other wireless technologies.

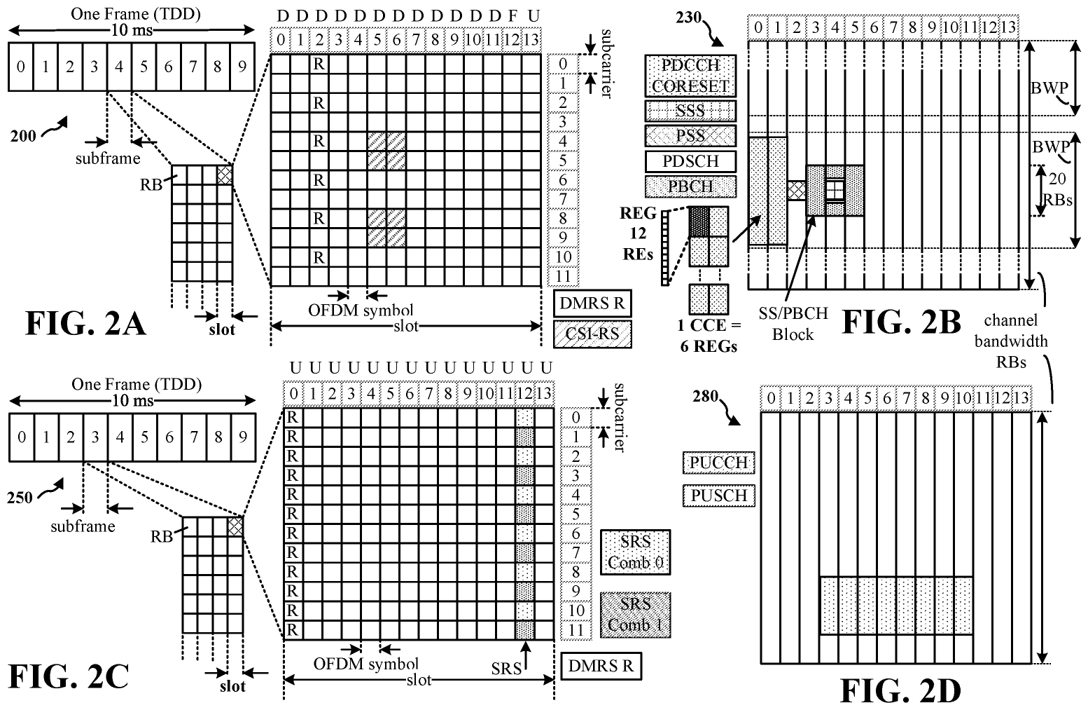

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

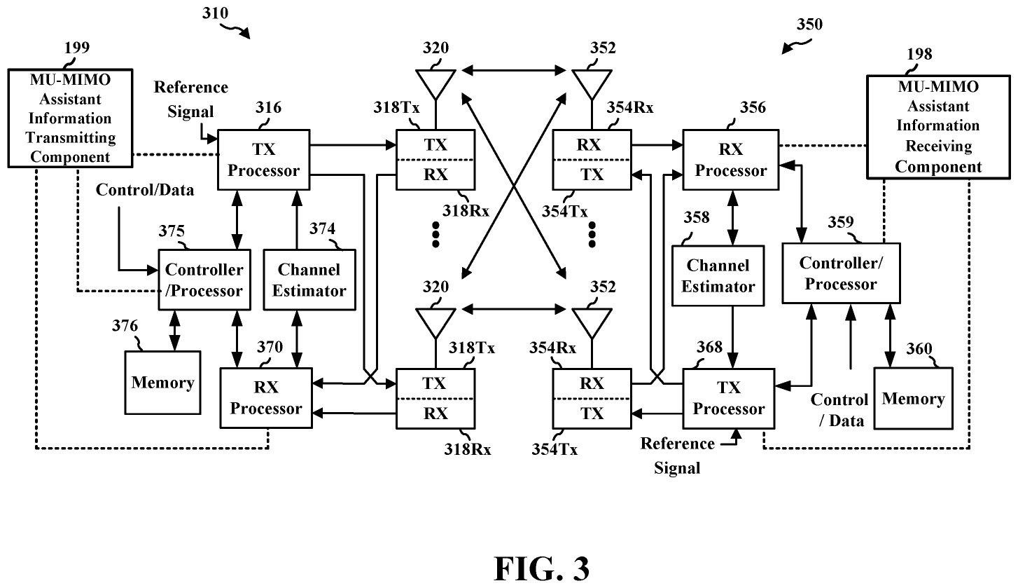

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the MU-MIMO assistance information receiving component 198 of FIG. 1. At least one of the TX processor 316, the RX processor 370, and the controller/processor 375 may be configured to perform aspects in connection with the MU-MIMO assistance information transmitting component 199 of FIG. 1.

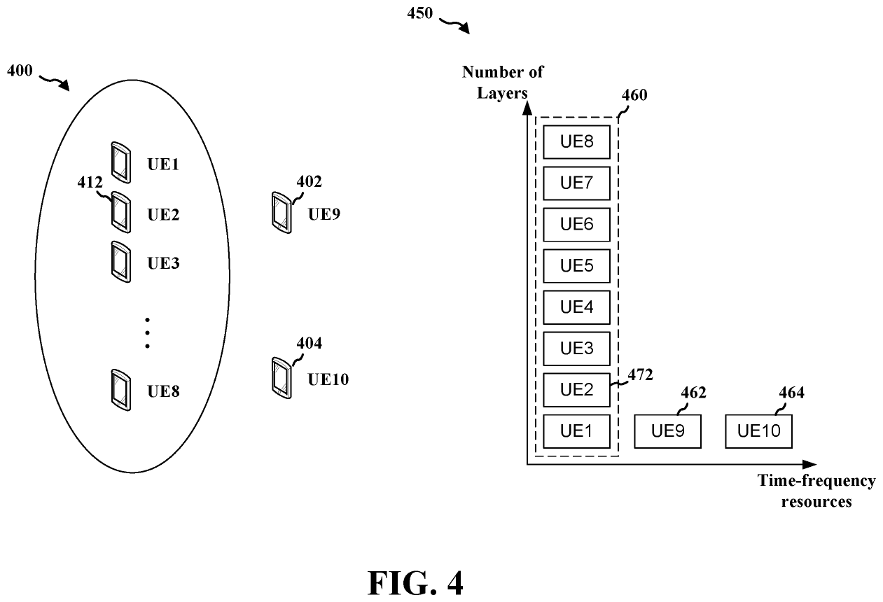

FIG. 4 includes diagrams illustrating wireless communication, including multiple UEs in multi-input multi-output (MIMO) operation. The multiple UEs in the MIMO operation may include multiple layers of data streams (e.g., including uplink (UL) and/or downlink (DL) communications) with one or more network nodes. The MIMO operation may include a single-user MIMO (SU-MIMO) configuration and a multiple-user MIMO (MU-MIMO) configuration. In one aspect, the SU-MIMO configuration may allow a single user to simultaneously send or receive the multiple data streams on one or more layers. Accordingly, the SU-MIMO configuration may increase the throughput for that single user and increase the capacity of the network. One or more SU-MIMO UEs, which may refer to the UEs operating under the SU-MIMO implementation, may not share the same time-frequency resources. For example, a ninth UE UE9 402 and a tenth UE UE10 404 may be operating in SU-MIMO. A ninth time-frequency resource 462 associated with the UE9 402 and a tenth time-frequency resource 464 associated with the UE10 404 may not share the same time-frequency resource.

In another aspect, the MU-MIMO configuration may implement spatial multiplexing of time-frequency resources 450 for multiple UEs. That is, the MU-MIMO configuration may allow multiple wireless devices to simultaneously send or multiplex the multiple data streams on one or more communication layers transmitted on multiple beams to increase the network capacity. For example, the multiple UEs 400 may include multiple MU-MIMO UEs, which may refer to the UEs operating under the MU-MIMO implementation. The multiple UEs 400 may include a first UE UE1 to an eighth UE UE8, and the multiple UEs 400 may be paired for the MU-MIMO operation, and the multiple UEs 400 may share the same time-frequency resource 460. Each MU-MIMO UEs may be configured with a certain number of layers to communicate with the network node under the MU-MIMO implementation. Here, the second UE 412 (UE2) may be configured with a second set of layers 472 to perform the MIMO communication with the network node.

The multiple MU-MIMO UEs may share the same time-frequency resources. The more the channels between the multiple UEs that are orthogonal, the smaller the interference and the higher the capacity and spectral efficiency may be. That is, the orthogonality of the channels of the multiple MU-MIMO UEs may affect the interference between the multiple MU-MIMO UEs and the capacity and spectral efficiency of the wireless communication.

The number of layers configured for the MU-MIMO UEs may be typically less than the number of layers configured for the SU-MIMO UEs. For example, the MU-MIMO UEs may have maximum number of one (1) layer or two (2) layers, and the SU-MIMO UEs may have maximum number of four (4) layers. Here, the number of layers that can be supported, which may be referred to as a rank, may be limited by the number of receiver antennas on the UE (e.g., the SU-MIMO UE or the MU-MIMO UE) side. For example, each of the MU-MIMO UEs 400 including the second UE 412 (UE2) may be configured with two (2) layers (e.g., total sixteen (16) layers for the MU-MIMO UEs 400), and the SU-MIMO UEs (e.g., the UE9 462 and the UE10) may be configured with four (4) layers.

In some aspects, the network node may transmit at least one configuration of the MIMO implementation for the UEs. In one aspect, the at least one configuration of the MIMO implementation may include the maximum number of layers configured for the UEs. Here, the indication of the maximum number of layers may not be distinguished for the SU-MIMO UEs and the MU-MIMO UEs. That is, the MIMO configuration including the number of maximum layers transmitted by the network node for both of the SU-MIMO UEs and the MU-MIMO UEs may have the same format or configurations.

Also, the UEs may be configured to report the CSI or transmit the SRS using the same configuration of CSI report configuration or SRS antenna port configuration for both the SU-MIMO configuration and the MU-MIMO configuration. That is, the SU-MIMO UEs and the MU-MIMO UEs may be configured with the same parameters or configurations to generate and transmit the CSI report or transmit the SRS. Accordingly, the MU-MIMO UEs may be configured to generate and transmit the CSI report or transmit the SRS based on the configurations (e.g., RI or CQI) that is be transmitted to the SU-MIMO UEs.

In some aspects, each layer may be mapped with a corresponding demodulation reference signal (DM-RS) port, and each layer may be identified by the DM-RS port. The network node may transmit downlink control information (DCI) in a physical downlink control channel (PDCCH) indicating a DM-RS code division multiplexing (CDM) group without data. Accordingly, each MU-MIMO UE may receive the corresponding DCI in the PDCCH indicating the DM-RS CDM group for each MU-MIMO UE. However, the network node may not indicate other DM-RS without data of other UEs, or indicate other DM-RS used for DM-RS rate matching for not allowing the PDSCH and DM-RS FDM. Therefore, the MU-MIMO UE may not be aware of the MU-MIMO configuration of other MU-MIMO UEs paired with the MU-MIMO UE. For example, a second UE 412 (UE2) corresponding with the second set of layers 472 may not be aware of whether other layers are occupied by other MU-MIMO UEs and/or the MU-MIMO configuration associated with the other MU-MIMO UEs.

Accordingly, the MU-MIMO UE may perform inter-layer interference cancelation (IC) without inter-layer information of other layers. That is, the inter-layer IC performed by the UE in the MU-MIMO configuration may be less optimized, and result in non-optimized link adaption performance.

In some aspects, the network node may transmit a first indication of MU-MIMO assistance information to the one or more MU-MIMO UEs. That is, based on configuring a MU-MIMO configuration for a UE or receiving a request from a MU-MIMO UE, the network node may transmit the MU-MIMO assistance information to the MU-MIMO UEs, and the MU-MIMO UEs may coordinate the operation with the received MU-MIMO assistance information and perform the inter-layer IC or transmit the CSI report or the SRS based on the MU-MIMO assistance information. Here, the MU-MIMO assistance information may refer to a set of information associated with configurations of the MU-MIMO and/or the SU-MIMO.

In one aspect, the MU-MIMO assistance information may include a separate maximum RI for MU-MIMO and SU-MIMO. The maximum number of layers in the MU-MIMO may be smaller than the maximum number of layers in the SU-MIMO. For example, the maximum number of layers in the MU-MIMO may be one (1), and the maximum number of layers in the SU-MIMO may be four (4).

In another aspect, the MU-MIMO assistance information may include the number of UEs in the MU-MIMO pair and the corresponding beam identifier (ID) and a precoding matrix indicator (PMI). That is, the MU-MIMO assistance information may indicate the number of other UEs paired with the MU-MIMO UE and the associated beam ID and the PMI of the other UEs paired with the MU-MIMO UE. Based on the number of other UEs in the MU-MIMO pair and the corresponding beam ID and the PMI, the MU-MIMO UE may have a better understanding of the signal transmission and reception by UEs in the MU-MIMO pair on different layers which may cause interference, and may improve the accuracy of the inter-layer IC, the CSI report, or the SRS.

In another aspect, the MU-MIMO assistance information may include inter-UE spatial correlation. The MU-MIMO implementation may include different layers that may be associated with different sets of antennas on the UE side and the network node side, and therefore, each MU-MIMO may be spatially correlated with the associated one or more layers. Based on the inter-UE spatial correlation, the MU-MIMO UE may have a better understanding of the signal transmission and reception by UEs in the MU-MIMO pair on different layers which may cause interference, and may improve the accuracy of the inter-layer IC, the CSI report, or the SRS.

In another aspect, the MU-MIMO assistance information may include overlapped physical resource blocks (PRBs). That is, the MU-MIMO assistance information may indicate the PRBs on the layer of the MU-MIMO UE that overlaps with the other UEs in the MU-MIMO pair, and the MU-MIMO UE may understand that the indicated PRBs may have an increased effect or interference from the overlapped PRBs. Based on the indication of the overlapped PRBs, the MU-MIMO UE may improve the accuracy of the inter-layer IC, the CSI report, or the SRS.

In another aspect, the MU-MIMO assistance information may include the DM-RS CDM group usage for the other UE PDSCH or the DM-RS rate matching information. That is, the MU-MIMO assistance information may indicate the DM-RS CDM group or the DM-RS rate matching information for the other MU-MIMO UEs in the MU-MIMO pair, and the MU-MIMO UE may have a better understanding of interference that may be caused by the DM-RS and rate matched data signals in the layers associated with the other MU-MIMO UEs in the MU-MIMO pair. Based on the indication of the DM-RS CDM group and the DM-RS rate matching information for the other MU-MIMO UEs in the MU-MIMO pair, the MU-MIMO UE may improve the accuracy of the inter-layer IC, the CSI report, or the SRS.

In another aspect, the MU-MIMO assistance information may include the trigger cause of the MU-MIMO. The trigger cause of the MU-MIMO may indicate the MU-MIMO assistance information for the other MU-MIMO UEs in the MU-MIMO pair, and the MU-MIMO UE may improve the accuracy of the inter-layer IC, the CSI report, or the SRS based on the trigger cause of the MU-MIMO.

The MU-MIMO UE may perform the IC or transmit CSI report or SRS based on the MU-MIMO assistance information. In one aspect, the UE may perform the inter-layer IC based on the MU-MIMO assistance information on the MU-MIMO pairing received from the network node. In another aspect, the UE may perform the CSI reporting (e.g., channel quality indicator (CQI), RI, PMI) or transmit SRS based on MU-MIMO maximum layer restriction.

For the SU-MIMO UEs, the network node may indicate the configurations of the SU-MIMO operation to the SU-MIMO UE, and the SU-MIMO UE may perform the IC and transmit the CSI report or SRS based on the SU-MIMO configurations.

The MU-MIMO UE may improve the link adaptation based on the MU-MIMO assistance information. That is, based on the MU-MIMO assistance information received from the network node, the MU-MIMO UE may perform the inter-layer IC, improve the CSI and report CQI or optimize the SRS transmission based on MU-MIMO layer restriction accordingly, to improve the link adaptation.

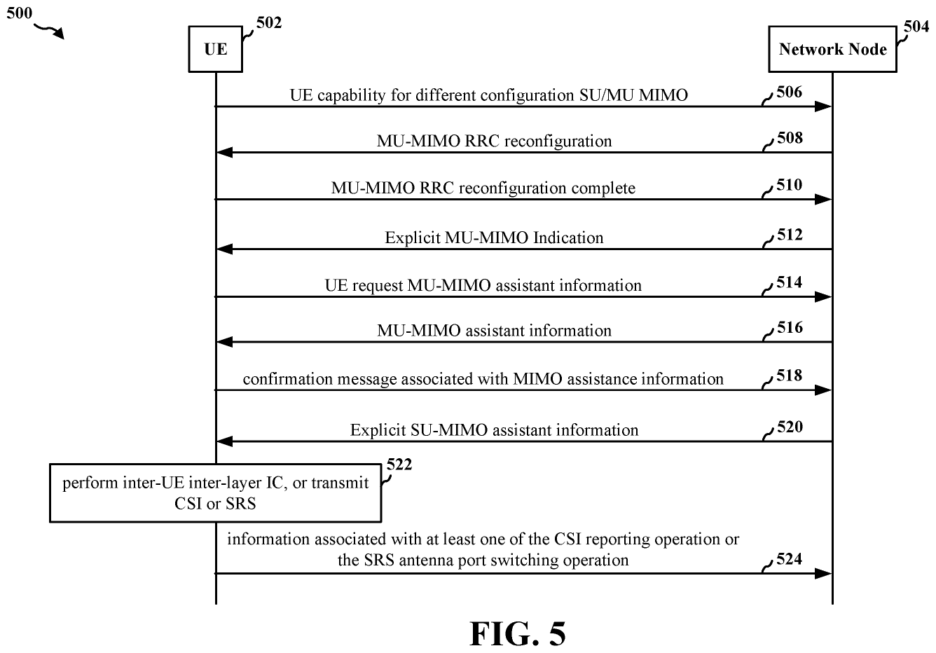

FIG. 5 is a call-flow diagram 500 of a method of wireless communication. The call-flow diagram 500 may include a UE 502 and a network node 504. The UE 502 may be a MIMO UE that may operate under either a SU-MIMO operation or a MU-MIMO operation, and may have the capability to receive MU-MIMO assistance information from the network node 504 and utilize the MU-MIMO assistance information received from the network node 504 to perform the inter-layer IC or transmit the CSI report or the SRS.

At 506, the UE 502 may transmit a third indication of a UE capability for at least one of a separate IC associated with at least one of the SU-MIMO or the MU-MIMO, a separate CSI reporting associated with the SU-MIMO or the MU-MIMO, or a separate SRS transmission associated with the SU-MIMO or the MU-MIMO. The network node 504 may obtain a third indication of a UE capability for at least one of a separate IC associated with at least one of the SU-MIMO or the MU-MIMO, a separate CSI reporting associated with the SU-MIMO or the MU-MIMO, or a separate SRS transmission associated with the SU-MIMO or the MU-MIMO. The UE 502 may notify the network node 504 that the UE 502 has the capability to perform certain operations differently for the SU-MIMO and the MU-MIMO configurations. In one example, the UE 502 may notify the network node 504 that the UE 502 may perform the inter-UE inter-layer IC differently for the SU-MIMO and the MU-MIMO with different parameters. In another example, the UE 502 may notify the network node 504 that the UE 502 may generate and transmit the CSI report differently for the SU-MIMO and the MU-MIMO with different parameters. In another example, the UE 502 may notify the network node 504 that the UE 502 may perform the SRS antenna port switching operation differently for the SU-MIMO and the MU-MIMO with different parameters. The first indication of MIMO assistance information may be transmitted at 516 based on the obtaining of the third indication of the UE capability. That is, the network node 504 may obtain the capabilities of the UE 502, and transmit the MIMO assistance information that may be relevant to the capabilities of the UE 502.

At 508, the network node 504 may transmit an RRC configuration or reconfiguration associated with at least one of the SU-MIMO or the MU-MIMO. The UE 502 may receive an RRC configuration or reconfiguration associated with at least one of the SU-MIMO or the MU-MIMO. The network node 504 may configure the UE 502 with the MU-MIMO operation or the SU-MIMO operation. In one aspect, the UE 502 may be configured with the SU-MIMO operation. The UE 502 configured with the SU-MIMO operation (e.g., the ninth UE UE9 402 or the tenth UE UE10 404 of FIG. 4) may not share the same time-frequency resources. In another aspect, the UE 502 may be configured with the MU-MIMO operation. The UE 502 configured with the MU-MIMO operation (e.g., the multiple UEs 400 including the first UE UE1 to the eighth UE UE8 of FIG. 4) may share the same time-frequency resource (e.g., the time-frequency resource 460 of FIG. 4).

The RRC configuration or reconfiguration may include the maximum number of layers configured for the UEs. The number of layers (i.e., rank) configured for the MU-MIMO UEs may be typically less than the number of layers configured for the SU-MIMO UEs. For example, the MU-MIMO UEs may have maximum number of one (1) layer or two (2) layers, and the SU-MIMO UEs may have maximum number of four (4) layers. However, the indication of the maximum number of layers may not be distinguished for the SU-MIMO UEs and the MU-MIMO UEs. That is, the MIMO configuration including the number of maximum layers transmitted by the network node 504 for both of the SU-MIMO UEs and the MU-MIMO UEs may have the same format or configurations.

The RRC configuration or reconfiguration may also include a configuration of the SCI reporting or SRS transmission including the SRS antenna port configuration. However, the UE 502 in the MU-MIMO operation may be configured with the same parameters or configurations to generate and transmit the CSI report or transmit the SRS. Accordingly, the UE 502 may be configured to generate and transmit the CSI report or transmit the SRS based on the configurations (e.g., RI or CQI) that is be transmitted to the SU-MIMO UEs, and the UE 502 may not be aware of the MU-MIMO configuration of other MU-MIMO UEs paired with the UE 502.

At 510, the UE 502 may transmit a second indication of completion of the RRC configuration or reconfiguration associated with at least one of the SU-MIMO or the MU-MIMO at the UE 502. The network node 504 may obtain a second indication of completion of the RRC configuration or reconfiguration associated with at least one of the SU-MIMO or the MU-MIMO at the UE 502. That is, in response to the RRC configuration or reconfiguration associated with at least one of the SU-MIMO or the MU-MIMO received at 508, the UE 502 may indicate to the network node 504 that the UE 502 is configured with the RRC configuration or reconfiguration associated with the at least one of the SU-MIMO or the MU-MIMO. The network node 504 may activate or deactivate configurations associated with the at least one of the SU-MIMO operation or the MU-MIMO operation. Furthermore, the first indication of MIMO assistance information may be received at 516 based on the second indication of the completion of the RRC configuration or reconfiguration.

At 512, the network node 504 may transmit a fourth indication of the MU-MIMO operation to the UE 502. The UE 502 may receive a fourth indication of the MU-MIMO operation from the network node 504. That is, the network node 504 may indicate the UE 502 to operate in the MU-MIMO mode. In one aspect, the fourth indication of the MU-MIMO operation may activate at least one configuration of the MU-MIMO operation received at 508. The first indication of MIMO assistance information may be received at 516 based on the transmission of the fourth indication of the MU-MIMO operation to the UE 502.

At 514, the UE 502 may transmit a request for the MIMO assistance information associated with at least one of the SU-MIMO operation or the MU-MIMO operation to the network node 504 based on receiving the fourth indication of the MU-MIMO operation at 512. The network node 504 may obtain a request for the MIMO assistance information associated with at least one of the SU-MIMO operation or the MU-MIMO operation to the network node 504 based on transmitting the fourth indication of the MU-MIMO operation at 512. That is, based on the UE 502 receiving the explicit fourth indication of the MU-MIMO operation at 512 from the network node 504, the UE 502 may transmit a request to the network node 504 requesting for the MIMO assistance information associated with at least one of a SU-MIMO configuration or a MU-MIMO configuration. The first indication of the MIMO assistance information may be received based on transmitting the request for the MIMO assistance information.

At 516, the network node 504 may transmit a first indication of MIMO assistance information for a UE 502, where the MIMO assistance information is associated with at least one of a SU-MIMO configuration or a MU-MIMO configuration. The UE 502 may receive a first indication of MIMO assistance information from a network node 504, where the MIMO assistance information is associated with at least one of a SU-MIMO configuration or a MU-MIMO configuration.

Here, the MIMO assistance information may include at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration.

Based on the MIMO assistance information, the UE 502 may perform at least one of an inter-layer IC operation, a CSI reporting operation, or an SRS antenna port switching operation based on at least one of the SU-MIMO configuration or the MU-MIMO configuration at 522. That is, the UE 502 may perform at least one of the inter-layer IC operation, the CSI reporting operation, or the SRS antenna port switching operation based on the MIMO assistance information associated with the at least one of the SU-MIMO configuration or the MU-MIMO configuration received at 522. In one example, the UE 502 may perform the inter-layer IC to cancel the interferences caused by signals in other layers associated with other UEs. In another example, the UE 502 may generate and transmit the CSI report based on existence of signals in other layers associated with other UEs. In another example, the UE 502 may select or switch the SRS antenna port to reduce the interferences with other UEs associated with other layers.

The first indication of the MIMO assistance information may be received via RRC message, DCI, or MAC-CE. In one aspect, the first indication of MIMO assistance information may be received based on the second indication of the completion of the RRC configuration or reconfiguration at 510. In another aspect, the first indication of MIMO assistance information may be received based on the transmission of the third indication of the UE capability at 512. In another aspect, the first indication of the MIMO assistance information is received based on transmitting the request for the MIMO assistance information at 514.

At 518, the UE 502 may transmit a confirmation message associated with the MIMO assistance information to the network node 504, where the confirmation message is transmitted after receiving the first indication of the MIMO assistance information at 516. The network node 504 may obtain a confirmation message associated with the MIMO assistance information to the network node 504, where the confirmation message is obtained after transmitting the first indication of the MIMO assistance information at 516.

At 520, the network node 504 may transmit a fifth indication of the SU-MIMO operation to the UE 502. The UE 502 may receive a fifth indication of the SU-MIMO operation from the network node 504. That is, the network node 504 may indicate the UE 502 to operate in the SU-MIMO mode. In one aspect, the fifth indication of the SU-MIMO operation may activate at least one configuration of the SU-MIMO received at 508.

At 522, the UE 502 may perform at least one of an inter-layer IC operation, a CSI reporting operation, or an SRS antenna port switching operation based on at least one of the SU-MIMO configuration or the MU-MIMO configuration. Based on the fourth indication of the MU-MIMO operation received at 512 or the fifth indication of the SU-MIMO operation at 520, the UE 502 may perform the at least one of an inter-layer IC operation, the CSI reporting operation, or the SRS antenna port switching operation.

In one aspect, the inter-layer IC operation may be an intra-UE inter-layer IC operation for the SU-MIMO configuration or an inter-UE inter-layer IC operation for the MU-MIMO configuration. In another aspect, the CSI reporting operation for the SU-MIMO configuration may be different from the CSI reporting operation for the MU-MIMO configuration. In another aspect, the SRS antenna port switching operation for the SU-MIMO configuration may be different from the SRS antenna port switching operation for the MU-MIMO configuration.

In one example, the UE 502 may be configured with the MU-MIMO based on the fourth indication of the MU-MIMO operation received at 512, and the inter-layer IC operation may be inter-UE inter-layer IC, or the CSI reporting operation or the SRS antenna port switching operation may be based on low RI and/or high CQI. In another example, the UE 502 may be configured with the SU-MIMO based on the fifth indication of the SU-MIMO operation received at 520, and the inter-layer IC operation may be intra-UE inter-layer IC, or the CSI reporting operation or the SRS antenna port switching operation may be based on high RI and/or low CQI.

At 524, the UE 502 may transmit information associated with at least one of the CSI reporting operation or the SRS antenna port switching operation based on at least one of the SU-MIMO configuration or the MU-MIMO configuration. The network node 504 may obtain information associated with at least one of a CSI reporting operation or an SRS antenna port switching operation based on at least one of the SU-MIMO configuration or the MU-MIMO configuration.

In one example, the UE 502 may be configured with the MU-MIMO based on the fourth indication of the MU-MIMO operation received at 512, and the CSI reporting operation or the SRS antenna port switching operation may be based on low RI and/or high CQI. In another example, the UE 502 may be configured with the SU-MIMO based on the fifth indication of the SU-MIMO operation received at 520, and the CSI reporting operation or the SRS antenna port switching operation may be based on high RI and/or low CQI.

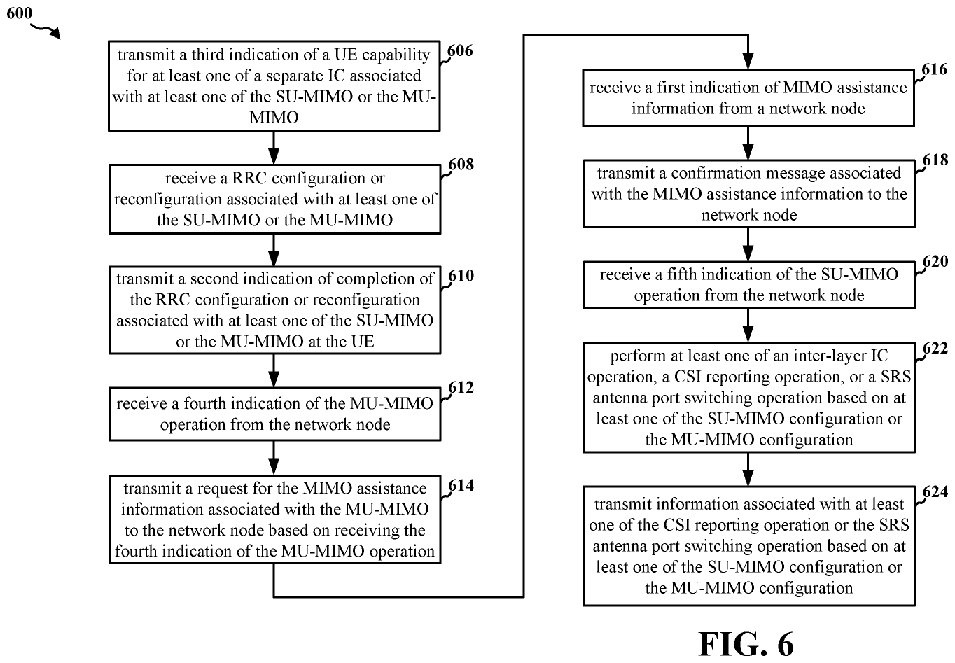

FIG. 6 is a flowchart 600 of a method of wireless communication. The method may be performed by a UE (e.g., the UE 104; the apparatus 1004). The UE may be the MIMO UE that may operate under either the SU-MIMO operation or the MU-MIMO operation, and may have the capability to receive the MU-MIMO assistance information from a network node and utilize the MU-MIMO assistance information received from the network node 504 to perform the inter-layer IC or transmit the CSI report or the SRS.

At 606, the UE may transmit a third indication of a UE capability for at least one of a separate IC associated with at least one of the SU-MIMO or the MU-MIMO, a separate CSI reporting associated with the SU-MIMO or the MU-MIMO, or a separate SRS transmission associated with the SU-MIMO or the MU-MIMO. The UE may notify the network node that the UE has the capability to perform certain operations differently for the SU-MIMO and the MU-MIMO configurations. In one example, the UE may notify the network node that the UE may perform the inter-UE inter-layer IC differently for the SU-MIMO and the MU-MIMO with different parameters. In another example, the UE may notify the network node that the UE may generate and transmit the CSI report differently for the SU-MIMO and the MU-MIMO with different parameters. In another example, the UE may notify the network node that the UE may perform the SRS antenna port switching operation differently for the SU-MIMO and the MU-MIMO with different parameters. The first indication of MIMO assistance information may be transmitted at 616 based on the obtaining of the third indication of the UE capability. That is, the network node may obtain the capabilities of the UE, and transmit the MIMO assistance information that may be relevant to the capabilities of the UE. For example, at 506, the UE 502 may transmit a third indication of a UE capability for at least one of a separate IC associated with at least one of the SU-MIMO or the MU-MIMO, a separate CSI reporting associated with the SU-MIMO or the MU-MIMO, or a separate SRS transmission associated with the SU-MIMO or the MU-MIMO. Furthermore, 606 may be performed by a MU-MIMO assistance information receiving component 198.

At 608, the UE may receive an RRC configuration or reconfiguration associated with at least one of the SU-MIMO or the MU-MIMO. The network node may configure the UE with the MU-MIMO operation or the SU-MIMO operation. In one aspect, the UE may be configured with the SU-MIMO. The UE configured with the SU-MIMO (e.g., the ninth UE UE9 402 or the tenth UE UE10 404 of FIG. 4) may not share the same time-frequency resources. In another aspect, the UE may be configured with the MU-MIMO. The UE configured with the MU-MIMO (e.g., the multiple UEs 400 including the first UE UE 1 to the eighth UE UE8 of FIG. 4) may share the same time-frequency resource (e.g., the time-frequency resource 460 of FIG. 4). For example, at 508, the UE 502 may receive an RRC configuration or reconfiguration associated with at least one of the SU-MIMO or the MU-MIMO. Furthermore, 608 may be performed by the MU-MIMO assistance information receiving component 198.

The RRC configuration or reconfiguration may include the maximum number of layers configured for the UEs. The number of layers (i.e., rank) configured for the MU-MIMO UEs may be typically less than the number of layers configured for the SU-MIMO UEs. For example, the MU-MIMO UEs may have maximum number of one (1) layer or two (2) layers, and the SU-MIMO UEs may have maximum number of four (4) layers. However, the indication of the maximum number of layers may not be distinguished for the SU-MIMO UEs and the MU-MIMO UEs. That is, the MIMO configuration including the number of maximum layers transmitted by the network node for both of the SU-MIMO UEs and the MU-MIMO UEs may have the same format or configurations.

The RRC configuration or reconfiguration may also include configuration of the SCI reporting or SRS transmission including the SRS antenna port configuration. However, the UE in the MU-MIMO may be configured with the same parameters or configurations to generate and transmit the CSI report or transmit the SRS. Accordingly, the MU-MIMO UE may be configured to generate and transmit the CSI report or transmit the SRS based on the configurations (e.g., RI or CQI) that is be transmitted to the SU-MIMO UEs, and the MU-MIMO UE may not be aware of the MU-MIMO configuration of other MU-MIMO UEs paired with the MU-MIMO UE.

At 610, the UE may transmit a second indication of completion of the RRC configuration or reconfiguration associated with at least one of the SU-MIMO or the MU-MIMO at the UE. That is, in response to the RRC configuration or reconfiguration associated with at least one of the SU-MIMO or the MU-MIMO received at 608, the UE may indicate to the network node that the UE is configured with the RRC configuration or reconfiguration associated with the at least one of the SU-MIMO or the MU-MIMO. The network node and activate or deactivate configurations associated with the at least one of the SU-MIMO or the MU-MIMO. Furthermore, the first indication of MIMO assistance information may be received at 616 based on the second indication of the completion of the RRC configuration or reconfiguration. For example, at 510, the UE 502 may transmit a second indication of completion of the RRC configuration or reconfiguration associated with at least one of the SU-MIMO or the MU-MIMO at the UE 502. Furthermore, 610 may be performed by the MU-MIMO assistance information receiving component 198.

At 612, the UE may receive a fourth indication of the MU-MIMO operation from the network node. That is, the network node may indicate the UE to operate in the MU-MIMO mode. In one aspect, the fourth indication of the MU-MIMO operation may activate at least one configuration of the MU-MIMO received at 608. The first indication of MIMO assistance information may be received at 616 based on the transmission of the fourth indication of the MU-MIMO operation to the UE. For example, at 512, the UE 502 may receive a fourth indication of the MU-MIMO operation from the network node 504. Furthermore, 612 may be performed by the MU-MIMO assistance information receiving component 198.

At 614, the UE may transmit a request for the MIMO assistance information associated with at least one of the SU-MIMO or the MU-MIMO to the network node based on receiving the fourth indication of the MU-MIMO operation at 612. That is, based on the UE receiving the explicit fourth indication of the MU-MIMO operation at 612 from the network node, the UE may transmit a request to the network node requesting for the MIMO assistance information associated with at least one of a SU-MIMO configuration or a MU-MIMO configuration. The first indication of the MIMO assistance information may be received based on transmitting the request for the MIMO assistance information. For example, at 514, the UE 502 may transmit a request for the MIMO assistance information associated with at least one of the SU-MIMO or the MU-MIMO to the network node 504 based on receiving the fourth indication of the MU-MIMO operation at 512. Furthermore, 614 may be performed by the MU-MIMO assistance information receiving component 198.

At 616, the UE may receive a first indication of MIMO assistance information from a network node, where the MIMO assistance information is associated with at least one of a SU-MIMO configuration or a MU-MIMO configuration. For example, at 516, the UE 502 may receive a first indication of MIMO assistance information from a network node 504, where the MIMO assistance information is associated with at least one of a SU-MIMO configuration or a MU-MIMO configuration. Furthermore, 616 may be performed by a MU-MIMO assistance information receiving component 198.

Here, the MIMO assistance information may include at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration.

Based on the MIMO assistance information, the UE may perform at least one of an inter-layer IC operation, a CSI reporting operation, or an SRS antenna port switching operation based on at least one of the SU-MIMO configuration or the MU-MIMO configuration at 622.

The first indication of the MIMO assistance information may be received via RRC message, DCI, or MAC-CE. In one aspect, the first indication of MIMO assistance information may be received based on the second indication of the completion of the RRC configuration or reconfiguration at 610. In another aspect, the first indication of MIMO assistance information may be received based on the transmission of the third indication of the UE capability at 612. In another aspect, the first indication of the MIMO assistance information is received based on transmitting the request for the MIMO assistance information at 614.

At 618, the UE may transmit a confirmation message associated with the MIMO assistance information to the network node, where the confirmation message is transmitted after receiving the first indication of the MIMO assistance information at 616. For example, at 518, the UE 502 may transmit a confirmation message associated with the MIMO assistance information to the network node 504, where the confirmation message is transmitted after receiving the first indication of the MIMO assistance information at 516. Furthermore, 618 may be performed by the MU-MIMO assistance information receiving component 198.

At 620, the UE may receive a fifth indication of the SU-MIMO operation from the network node. That is, the network node may indicate the UE to operate in the SU-MIMO mode. In one aspect, the fifth indication of the SU-MIMO operation may activate at least one configuration of the SU-MIMO received at 608. For example, at 520, the UE 502 may receive a fifth indication of the SU-MIMO operation from the network node 504. Furthermore, 620 may be performed by the MU-MIMO assistance information receiving component 198.

At 622, the UE may perform at least one of an inter-layer IC operation, a CSI reporting operation, or an SRS antenna port switching operation based on at least one of the SU-MIMO configuration or the MU-MIMO configuration. Based on the fourth indication of the MU-MIMO operation received at 612 or the fifth indication of the SU-MIMO operation at 620, the UE may perform the at least one of an inter-layer IC operation, the CSI reporting operation, or the SRS antenna port switching operation. For example, at 522, the UE 502 may perform at least one of an inter-layer IC operation, a CSI reporting operation, or an SRS antenna port switching operation based on at least one of the SU-MIMO configuration or the MU-MIMO configuration. Furthermore, 622 may be performed by the MU-MIMO assistance information receiving component 198.

In one aspect, the inter-layer IC operation may be an intra-UE inter-layer IC operation for the SU-MIMO configuration or an inter-UE inter-layer IC operation for the MU-MIMO configuration. In another aspect, the CSI reporting operation for the SU-MIMO configuration may be different from the CSI reporting operation for the MU-MIMO configuration. In another aspect, the SRS antenna port switching operation for the SU-MIMO configuration may be different from the SRS antenna port switching operation for the MU-MIMO configuration.

In one example, the UE may be configured with the MU-MIMO based on the fourth indication of the MU-MIMO operation received at 612, and the inter-layer IC operation may be inter-UE inter-layer IC, or the CSI reporting operation or the SRS antenna port switching operation may be based on low RI and/or high CQI. In another example, the UE may be configured with the SU-MIMO based on the fifth indication of the SU-MIMO operation received at 620, and the inter-layer IC operation may be intra-UE inter-layer IC, or the CSI reporting operation or the SRS antenna port switching operation may be based on high RI and/or low CQI.

At 624, the UE may transmit information associated with at least one of the CSI reporting operation or the SRS antenna port switching operation based on at least one of the SU-MIMO configuration or the MU-MIMO configuration. In one example, the UE may be configured with the MU-MIMO based on the fourth indication of the MU-MIMO operation received at 612, and the CSI reporting operation or the SRS antenna port switching operation may be based on low RI and/or high CQI. In another example, the UE may be configured with the SU-MIMO based on the fifth indication of the SU-MIMO operation received at 620, and the CSI reporting operation or the SRS antenna port switching operation may be based on high RI and/or low CQI. For example, at 524, the UE 502 may transmit information associated with at least one of the CSI reporting operation or the SRS antenna port switching operation based on at least one of the SU-MIMO configuration or the MU-MIMO configuration. Furthermore, 624 may be performed by the MU-MIMO assistance information receiving component 198.

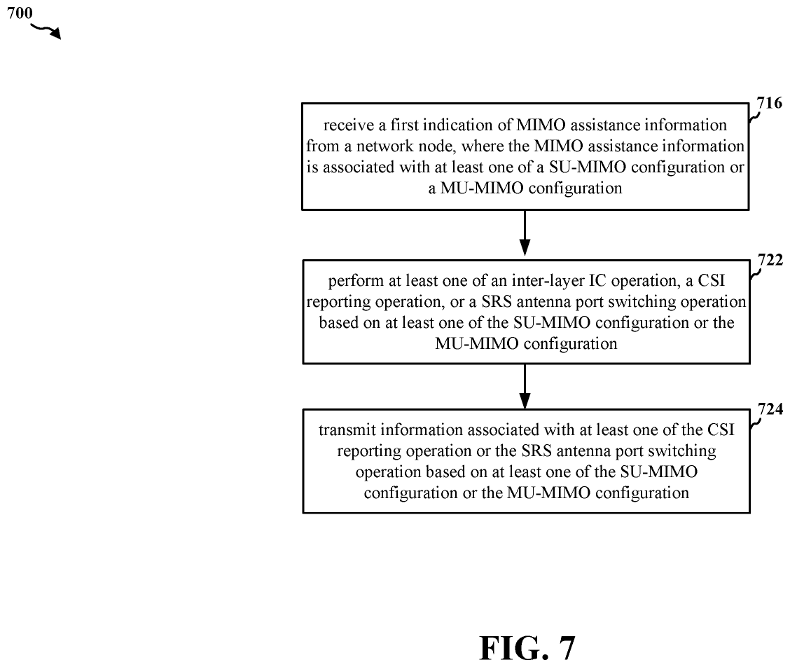

FIG. 7 is a flowchart 700 of a method of wireless communication. The method may be performed by a UE (e.g., the UE 104; the apparatus 1004). The UE may be the MIMO UE that may operate under either the SU-MIMO operation or the MU-MIMO operation, and may have the capability to receive the MU-MIMO assistance information from a network node and utilize the MU-MIMO assistance information received from the network node 504 to perform the inter-layer IC or transmit the CSI report or the SRS.

At 716, the UE may receive a first indication of MIMO assistance information from a network node, where the MIMO assistance information is associated with at least one of a SU-MIMO configuration or a MU-MIMO configuration. For example, at 516, the UE 502 may receive a first indication of MIMO assistance information from a network node 504, where the MIMO assistance information is associated with at least one of a SU-MIMO configuration or a MU-MIMO configuration. Furthermore, 716 may be performed by a MU-MIMO assistance information receiving component 198.

Here, the MIMO assistance information may include at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration.

Based on the MIMO assistance information, the UE may perform at least one of an inter-layer IC operation, a CSI reporting operation, or an SRS antenna port switching operation based on at least one of the SU-MIMO configuration or the MU-MIMO configuration at 722.

The first indication of the MIMO assistance information may be received via RRC message, DCI, or MAC-CE. In one aspect, the first indication of MIMO assistance information may be received based on the second indication of the completion of the RRC configuration or reconfiguration. In another aspect, the first indication of MIMO assistance information may be received based on the transmission of the third indication of the UE capability. In another aspect, the first indication of the MIMO assistance information is received based on transmitting the request for the MIMO assistance information.

At 722, the UE may perform at least one of an inter-layer IC operation, a CSI reporting operation, or an SRS antenna port switching operation based on at least one of the SU-MIMO configuration or the MU-MIMO configuration. Based on the fourth indication of the MU-MIMO operation received or the fifth indication of the SU-MIMO operation, the UE may perform the at least one of an inter-layer IC operation, the CSI reporting operation, or the SRS antenna port switching operation. For example, at 522, the UE 502 may perform at least one of an inter-layer IC operation, a CSI reporting operation, or an SRS antenna port switching operation based on at least one of the SU-MIMO configuration or the MU-MIMO configuration. Furthermore, 722 may be performed by the MU-MIMO assistance information receiving component 198.

In one aspect, the inter-layer IC operation may be an intra-UE inter-layer IC operation for the SU-MIMO configuration or an inter-UE inter-layer IC operation for the MU-MIMO configuration. In another aspect, the CSI reporting operation for the SU-MIMO configuration may be different from the CSI reporting operation for the MU-MIMO configuration. In another aspect, the SRS antenna port switching operation for the SU-MIMO configuration may be different from the SRS antenna port switching operation for the MU-MIMO configuration.

In one example, the UE may be configured with the MU-MIMO based on the fourth indication of the MU-MIMO operation, and the inter-layer IC operation may be inter-UE inter-layer IC, or the CSI reporting operation or the SRS antenna port switching operation may be based on low RI and/or high CQI. In another example, the UE may be configured with the SU-MIMO based on the fifth indication of the SU-MIMO operation, and the inter-layer IC operation may be intra-UE inter-layer IC, or the CSI reporting operation or the SRS antenna port switching operation may be based on high RI and/or low CQI.

At 724, the UE may transmit information associated with at least one of the CSI reporting operation or the SRS antenna port switching operation based on at least one of the SU-MIMO configuration or the MU-MIMO configuration. In one example, the UE may be configured with the MU-MIMO based on the fourth indication of the MU-MIMO operation, and the CSI reporting operation or the SRS antenna port switching operation may be based on low RI and/or high CQI. In another example, the UE may be configured with the SU-MIMO based on the fifth indication of the SU-MIMO operation, and the CSI reporting operation or the SRS antenna port switching operation may be based on high RI and/or low CQI. For example, at 524, the UE 502 may transmit information associated with at least one of the CSI reporting operation or the SRS antenna port switching operation based on at least one of the SU-MIMO configuration or the MU-MIMO configuration. Furthermore, 724 may be performed by the MU-MIMO assistance information receiving component 198.

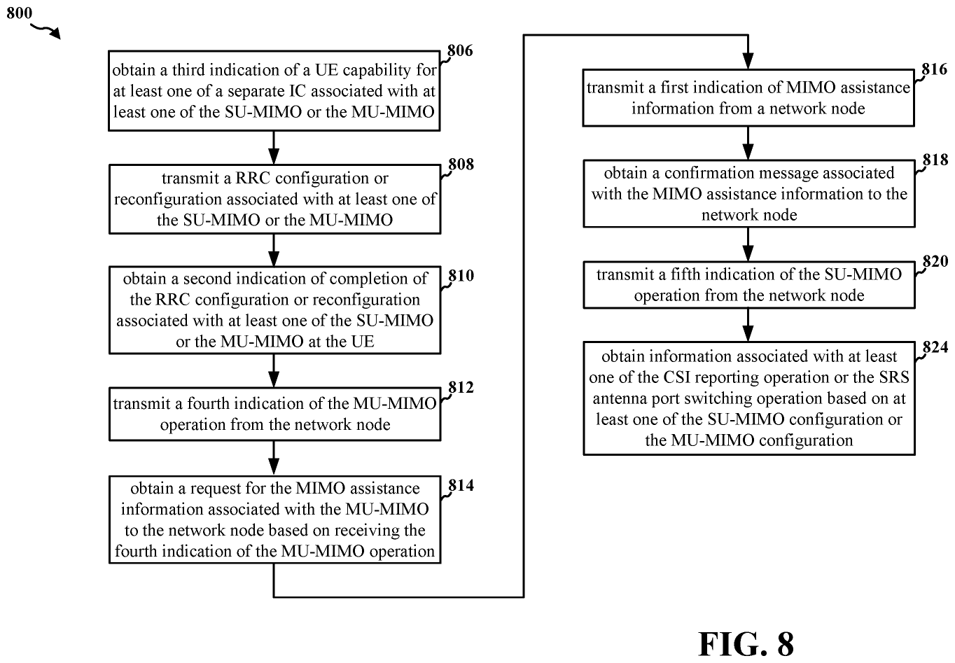

FIG. 8 is a flowchart 800 of a method of wireless communication. The method may be performed by a base station (e.g., the base station 102; the network entity 1102/1260). The base station may support one or the SU-MIMO operation or the MU-MIMO operation, and transmit the MU-MIMO assistance information to a UE that has the capability to receive and utilize the MU-MIMO assistance information to perform the inter-layer IC or transmit the CSI report or the SRS.

At 806, the base station may obtain a third indication of a UE capability for at least one of a separate IC associated with at least one of the SU-MIMO or the MU-MIMO, a separate CSI reporting associated with the SU-MIMO or the MU-MIMO, or a separate SRS transmission associated with the SU-MIMO or the MU-MIMO. The UE may notify the network node that the UE has the capability to perform certain operations differently for the SU-MIMO and the MU-MIMO configurations. In one example, the UE may notify the network node that the UE may perform the inter-UE inter-layer IC differently for the SU-MIMO and the MU-MIMO with different parameters. In another example, the UE may notify the network node that the UE may generate and transmit the CSI report differently for the SU-MIMO and the MU-MIMO with different parameters. In another example, the UE may notify the network node that the UE may perform the SRS antenna port switching operation differently for the SU-MIMO and the MU-MIMO with different parameters. The first indication of MIMO assistance information may be transmitted at 816 based on the obtaining of the third indication of the UE capability. That is, the network node may obtain the capabilities of the UE, and transmit the MIMO assistance information that may be relevant to the capabilities of the UE. For example, at 506, the network node 504 may obtain a third indication of a UE capability for at least one of a separate IC associated with at least one of the SU-MIMO or the MU-MIMO, a separate CSI reporting associated with the SU-MIMO or the MU-MIMO, or a separate SRS transmission associated with the SU-MIMO or the MU-MIMO. Furthermore, 806 may be performed by a MU-MIMO assistance information transmitting component 199.

At 808, the base station may transmit an RRC configuration or reconfiguration associated with at least one of the SU-MIMO or the MU-MIMO. The network node may configure the UE with the MU-MIMO operation or the SU-MIMO operation. In one aspect, the UE may be configured with the SU-MIMO. The UE configured with the SU-MIMO (e.g., the ninth UE UE9 402 or the tenth UE UE10 404 of FIG. 4) may not share the same time-frequency resources. In another aspect, the UE may be configured with the MU-MIMO. The UE configured with the MU-MIMO (e.g., the multiple UEs 400 including the first UE UE1 to the eighth UE UE8 of FIG. 4) may share the same time-frequency resource (e.g., the time-frequency resource 460 of FIG. 4). For example, at 508, the network node 504 may transmit an RRC configuration or reconfiguration associated with at least one of the SU-MIMO or the MU-MIMO. Furthermore, 808 may be performed by the MU-MIMO assistance information transmitting component 199.

The RRC configuration or reconfiguration may include the maximum number of layers configured for the UEs. The number of layers (i.e., rank) configured for the MU-MIMO UEs may be typically less than the number of layers configured for the SU-MIMO UEs. For example, the MU-MIMO UEs may have maximum number of one (1) layer or two (2) layers, and the SU-MIMO UEs may have maximum number of four (4) layers. However, the indication of the maximum number of layers may not be distinguished for the SU-MIMO UEs and the MU-MIMO UEs. That is, the MIMO configuration including the number of maximum layers transmitted by the network node for both of the SU-MIMO UEs and the MU-MIMO UEs may have the same format or configurations.

The RRC configuration or reconfiguration may also include configuration of the SCI reporting or SRS transmission including the SRS antenna port configuration. However, the UE in the MU-MIMO may be configured with the same parameters or configurations to generate and transmit the CSI report or transmit the SRS. Accordingly, the MU-MIMO UE may be configured to generate and transmit the CSI report or transmit the SRS based on the configurations (e.g., RI or CQI) that is be transmitted to the SU-MIMO UEs, and the MU-MIMO UE may not be aware of the MU-MIMO configuration of other MU-MIMO UEs paired with the MU-MIMO UE.

At 810, the base station may obtain a second indication of completion of the RRC configuration or reconfiguration associated with at least one of the SU-MIMO or the MU-MIMO at the UE. That is, in response to the RRC configuration or reconfiguration associated with at least one of the SU-MIMO or the MU-MIMO received at 808, the UE may indicate to the network node that the UE is configured with the RRC configuration or reconfiguration associated with the at least one of the SU-MIMO or the MU-MIMO. The network node and activate or deactivate configurations associated with the at least one of the SU-MIMO or the MU-MIMO. Furthermore, the first indication of MIMO assistance information may be received at 816 based on the second indication of the completion of the RRC configuration or reconfiguration. For example, at 510, the network node 504 may obtain a second indication of completion of the RRC configuration or reconfiguration associated with at least one of the SU-MIMO or the MU-MIMO at the UE 502. Furthermore, 810 may be performed by the MU-MIMO assistance information transmitting component 199.

At 812, the base station may transmit a fourth indication of the MU-MIMO operation to the UE. That is, the network node may indicate the UE to operate in the MU-MIMO mode. In one aspect, the fourth indication of the MU-MIMO operation may activate at least one configuration of the MU-MIMO received at 808. The first indication of MIMO assistance information may be received at 816 based on the transmission of the fourth indication of the MU-MIMO operation to the UE. For example, at 512, the network node 504 may transmit a fourth indication of the MU-MIMO operation to the UE 502. Furthermore, 812 may be performed by the MU-MIMO assistance information transmitting component 199.

At 814, the base station may obtain a request for the MIMO assistance information associated with at least one of the SU-MIMO or the MU-MIMO to the network node based on transmitting the fourth indication of the MU-MIMO operation at 812. That is, based on the UE receiving the explicit fourth indication of the MU-MIMO operation at 812 from the network node, the UE may transmit a request to the network node requesting for the MIMO assistance information associated with at least one of a SU-MIMO configuration or a MU-MIMO configuration. The first indication of the MIMO assistance information may be received based on transmitting the request for the MIMO assistance information. For example, at 514, the network node 504 may obtain a request for the MIMO assistance information associated with at least one of the SU-MIMO or the MU-MIMO to the network node 504 based on transmitting the fourth indication of the MU-MIMO operation at 512. Furthermore, 814 may be performed by the MU-MIMO assistance information transmitting component 199.

At 816, the base station may transmit a first indication of MIMO assistance information for a UE, where the MIMO assistance information is associated with at least one of a SU-MIMO configuration or a MU-MIMO configuration. For example, at 516, the network node 504 may transmit a first indication of MIMO assistance information for a UE 502, where the MIMO assistance information is associated with at least one of a SU-MIMO configuration or a MU-MIMO configuration. Furthermore, 816 may be performed by a MU-MIMO assistance information transmitting component 199.

Here, the MIMO assistance information may include at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration.

Based on the MIMO assistance information, the UE may perform at least one of an inter-layer IC operation, a CSI reporting operation, or an SRS antenna port switching operation based on at least one of the SU-MIMO configuration or the MU-MIMO configuration at 822.

The first indication of the MIMO assistance information may be received via RRC message, DCI, or MAC-CE. In one aspect, the first indication of MIMO assistance information may be received based on the second indication of the completion of the RRC configuration or reconfiguration at 810. In another aspect, the first indication of MIMO assistance information may be received based on the transmission of the third indication of the UE capability at 812. In another aspect, the first indication of the MIMO assistance information is received based on transmitting the request for the MIMO assistance information at 814.

At 818, the base station may obtain a confirmation message associated with the MIMO assistance information to the network node, where the confirmation message is obtained after transmitting the first indication of the MIMO assistance information at 816. For example, at 518, the network node 504 may obtain a confirmation message associated with the MIMO assistance information to the network node 504, where the confirmation message is obtained after transmitting the first indication of the MIMO assistance information at 516. Furthermore, 818 may be performed by the MU-MIMO assistance information transmitting component 199.

At 820, the base station may transmit a fifth indication of the SU-MIMO operation to the UE. That is, the network node may indicate the UE to operate in the SU-MIMO mode. In one aspect, the fifth indication of the SU-MIMO operation may activate at least one configuration of the SU-MIMO received at 808. For example, at 520, the network node 504 may transmit a fifth indication of the SU-MIMO operation to the UE 502. Furthermore, 820 may be performed by the MU-MIMO assistance information transmitting component 199.

At 824, the base station may obtain information associated with at least one of a CSI reporting operation or an SRS antenna port switching operation based on at least one of the SU-MIMO configuration or the MU-MIMO configuration. In one example, the UE may be configured with the MU-MIMO based on the fourth indication of the MU-MIMO operation received at 812, and the CSI reporting operation or the SRS antenna port switching operation may be based on low RI and/or high CQI. In another example, the UE may be configured with the SU-MIMO based on the fifth indication of the SU-MIMO operation received at 820, and the CSI reporting operation or the SRS antenna port switching operation may be based on high RI and/or low CQI. For example, at 524, the network node 504 may obtain information associated with at least one of a CSI reporting operation or an SRS antenna port switching operation based on at least one of the SU-MIMO configuration or the MU-MIMO configuration. Furthermore, 824 may be performed by the MU-MIMO assistance information transmitting component 199.

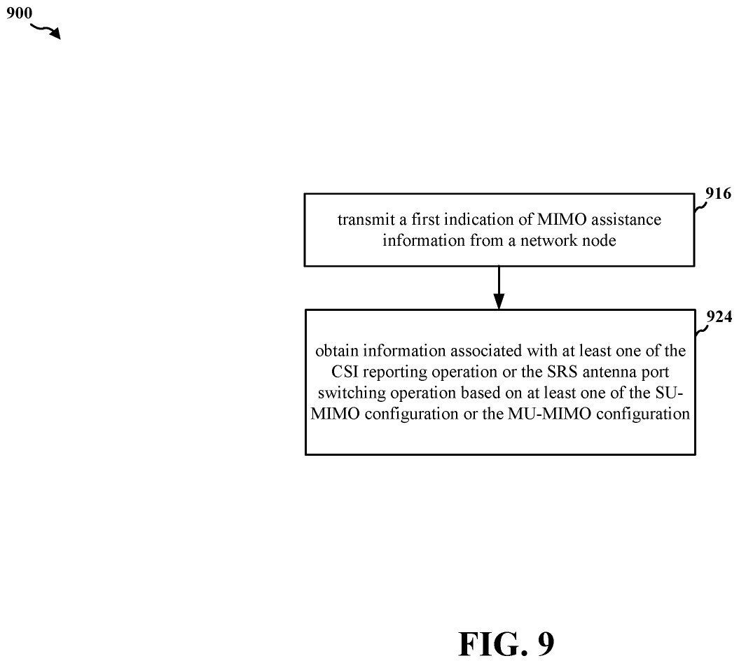

FIG. 9 is a flowchart 900 of a method of wireless communication. The method may be performed by a base station (e.g., the base station 102; the network entity 1102/1260). The base station may support one or the SU-MIMO operation or the MU-MIMO operation, and transmit the MU-MIMO assistance information to a UE that has the capability to receive and utilize the MU-MIMO assistance information to perform the inter-layer IC or transmit the CSI report or the SRS.

At 916, the base station may transmit a first indication of MIMO assistance information for a UE, where the MIMO assistance information is associated with at least one of a SU-MIMO configuration or a MU-MIMO configuration. For example, at 516, the network node 504 may transmit a first indication of MIMO assistance information for a UE 502, where the MIMO assistance information is associated with at least one of a SU-MIMO configuration or a MU-MIMO configuration. Furthermore, 916 may be performed by a MU-MIMO assistance information transmitting component 199.

Here, the MIMO assistance information may include at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration.

Based on the MIMO assistance information, the UE may perform at least one of an inter-layer IC operation, a CSI reporting operation, or an SRS antenna port switching operation based on at least one of the SU-MIMO configuration or the MU-MIMO configuration.

The first indication of the MIMO assistance information may be received via RRC message, DCI, or MAC-CE. In one aspect, the first indication of MIMO assistance information may be received based on the second indication of the completion of the RRC configuration or reconfiguration. In another aspect, the first indication of MIMO assistance information may be received based on the transmission of the third indication of the UE capability. In another aspect, the first indication of the MIMO assistance information is received based on transmitting the request for the MIMO assistance information.

At 924, the base station may obtain information associated with at least one of a CSI reporting operation or an SRS antenna port switching operation based on at least one of the SU-MIMO configuration or the MU-MIMO configuration. In one example, the UE may be configured with the MU-MIMO based on the fourth indication of the MU-MIMO operation received, and the CSI reporting operation or the SRS antenna port switching operation may be based on low RI and/or high CQI. In another example, the UE may be configured with the SU-MIMO based on the fifth indication of the SU-MIMO operation received, and the CSI reporting operation or the SRS antenna port switching operation may be based on high RI and/or low CQI. For example, at 524, the network node 504 may obtain information associated with at least one of a CSI reporting operation or an SRS antenna port switching operation based on at least one of the SU-MIMO configuration or the MU-MIMO configuration. Furthermore, 924 may be performed by the MU-MIMO assistance information transmitting component 199.

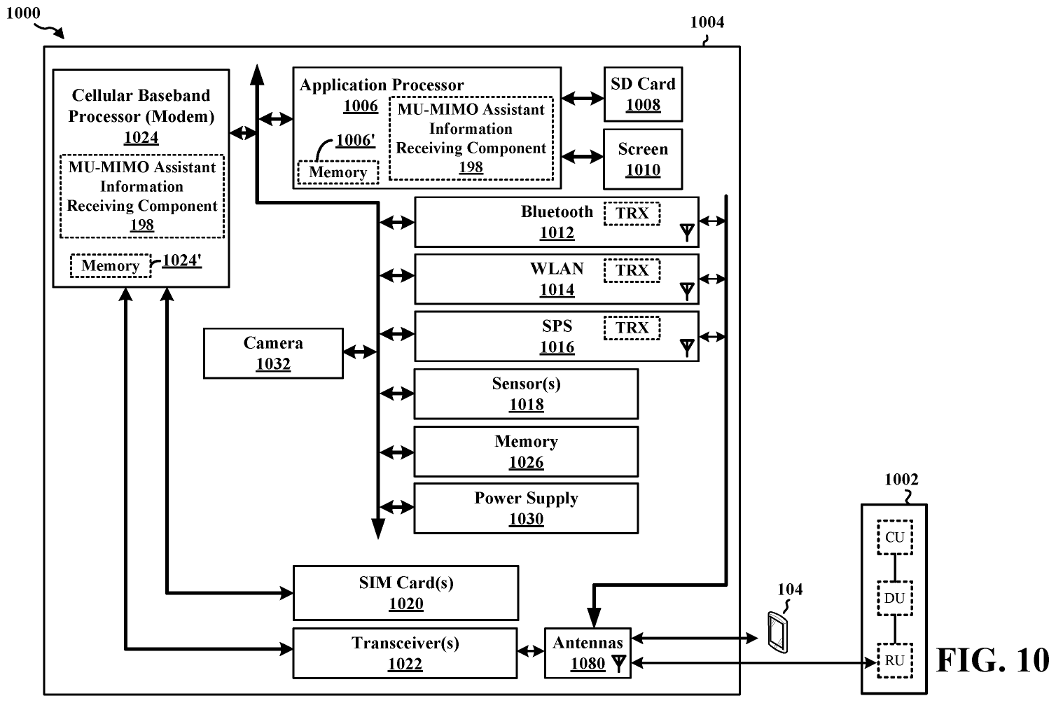

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see UE 350 of FIG. 3) and include the additional modules of the apparatus 1004.

As discussed supra, the MU-MIMO assistance information receiving component 198 is configured to receive a first indication of MIMO assistance information from a network node, where the MIMO assistance information is associated with at least one of a SU-MIMO configuration or a MU-MIMO configuration, perform at least one of an inter-layer IC operation, a CSI reporting operation, or an SRS antenna port switching operation based on at least one of the SU-MIMO configuration or the MU-MIMO configuration, and transmit information associated with at least one of the CSI reporting operation or the SRS antenna port switching operation based on at least one of the SU-MIMO configuration or the MU-MIMO configuration. The MU-MIMO assistance information receiving component 198 may be within the cellular baseband processor 1024, the application processor 1006, or both the cellular baseband processor 1024 and the application processor 1006. The MU-MIMO assistance information receiving component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for receiving a first indication of MIMO assistance information from a network node, where the MIMO assistance information is associated with at least one of a SU-MIMO configuration or a MU-MIMO configuration, means for performing at least one of an inter-layer IC operation, a CSI reporting operation, or an SRS antenna port switching operation based on at least one of the SU-MIMO configuration or the MU-MIMO configuration, and means for transmitting information associated with at least one of the CSI reporting operation or the SRS antenna port switching operation based on at least one of the SU-MIMO configuration or the MU-MIMO configuration. In one configuration, the MIMO assistance information includes at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration. In one configuration, the first indication of the MIMO assistance information is received via RRC message, DCI, or MAC-CE. In one configuration, the apparatus 1004, and in particular the cellular baseband processor 1024 and/or the application processor 1006, further includes means for transmitting a confirmation message associated with the MIMO assistance information to the network node, where the confirmation message is transmitted after receiving the first indication of the MIMO assistance information. In one configuration, the apparatus 1004, and in particular the cellular baseband processor 1024 and/or the application processor 1006, further includes means for receiving an RRC configuration or reconfiguration associated with at least one of the SU-MIMO or the MU-MIMO, and transmitting a second indication of completion of the RRC configuration or reconfiguration associated with at least one of the SU-MIMO or the MU-MIMO at the UE, where the first indication of MIMO assistance information is received based on the second indication of the completion of the RRC configuration or reconfiguration. In one configuration, the apparatus 1004, and in particular the cellular baseband processor 1024 and/or the application processor 1006, further includes means for transmitting a third indication of a UE capability for at least one of a separate IC associated with at least one of the SU-MIMO or the MU-MIMO, a separate CSI reporting associated with the SU-MIMO or the MU-MIMO, or a separate SRS transmission associated with the SU-MIMO or the MU-MIMO, where the first indication of MIMO assistance information is received based on the transmission of the third indication of the UE capability. In one configuration, the apparatus 1004, and in particular the cellular baseband processor 1024 and/or the application processor 1006, further includes means for receiving a fourth indication of the MU-MIMO operation from the network node, where the first indication of the MIMO assistance information is received based on receiving the fourth indication of the MU-MIMO operation. In one configuration, the apparatus 1004, and in particular the cellular baseband processor 1024 and/or the application processor 1006, further includes means for transmitting a request for the MIMO assistance information associated with at least one of the SU-MIMO or the MU-MIMO to the network node based on receiving the fourth indication of the MU-MIMO operation, where the first indication of the MIMO assistance information is received based on transmitting the request for the MIMO assistance information. In one configuration, the inter-layer IC operation is an intra-UE inter-layer IC operation for the SU-MIMO configuration or an inter-UE inter-layer IC operation for the MU-MIMO configuration. In one configuration, the CSI reporting operation for the SU-MIMO configuration is different from the CSI reporting operation for the MU-MIMO configuration. In one configuration, the SRS antenna port switching operation for the SU-MIMO configuration is different from the SRS antenna port switching operation for the MU-MIMO configuration. The means may be the MU-MIMO assistance information receiving component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

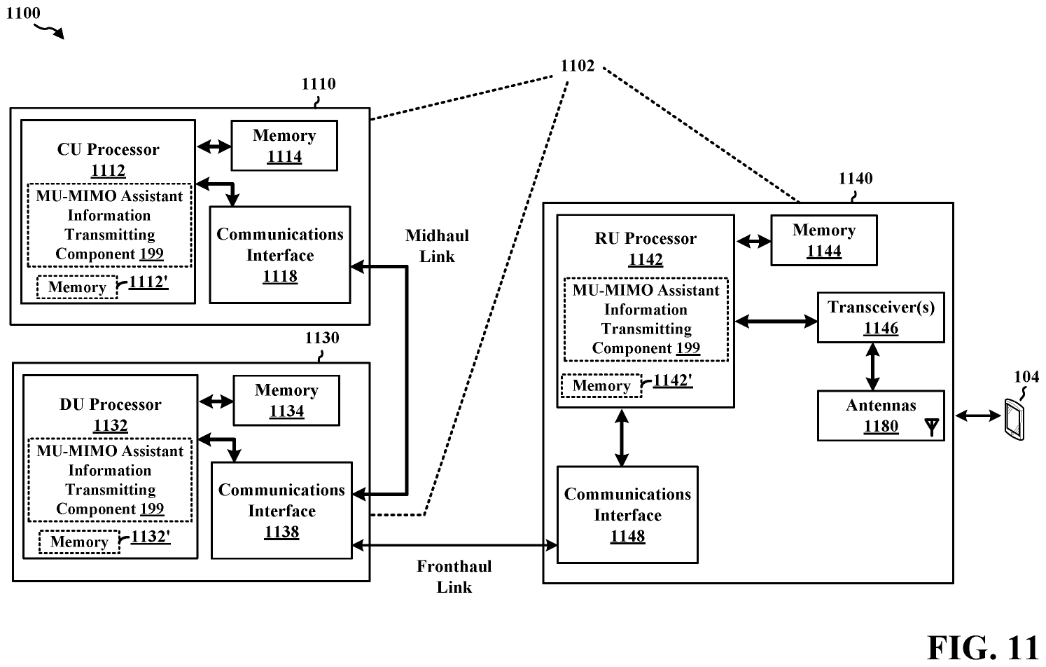

FIG. 11 is a diagram 1100 illustrating an example of a hardware implementation for a network entity 1102. The network entity 1102 may be a base station (BS), a component of a BS, or may implement BS functionality. The network entity 1102 may include at least one of a CU 1110, a DU 1130, or an RU 1140. For example, depending on the layer functionality handled by the MU-MIMO assistance information transmitting component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the MU-MIMO assistance information transmitting component 199 is configured to transmit a first indication of MIMO assistance information for a UE, where the MIMO assistance information is associated with at least one of a SU-MIMO configuration or a MU-MIMO configuration, and obtain information associated with at least one of a CSI reporting operation or an SRS antenna port switching operation based on at least one of the SU-MIMO configuration or the MU-MIMO configuration. The MU-MIMO assistance information transmitting component 199 may be within one or more processors of one or more of the CU 1110, DU 1130, and the RU 1140. The MU-MIMO assistance information transmitting component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for transmitting a first indication of MIMO assistance information for a UE, where the MIMO assistance information is associated with at least one of a SU-MIMO configuration or a MU-MIMO configuration, and means for obtaining information associated with at least one of a CSI reporting operation or an SRS antenna port switching operation based on at least one of the SU-MIMO configuration or the MU-MIMO configuration. In one configuration, the MIMO assistance information includes at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration. In one configuration, the first indication of the MIMO assistance information is transmitted via RRC message, DCI, or MAC-CE. In one configuration, the network entity 1102 further includes means for obtaining a confirmation message associated with the MIMO assistance information to the network node, where the confirmation message is obtained after transmitting the first indication of the MIMO assistance information. In one configuration, the network entity 1102 further includes means for transmitting an RRC configuration or reconfiguration associated with at least one of the SU-MIMO or the MU-MIMO, and obtaining a second indication of completion of the RRC configuration or reconfiguration associated with at least one of the SU-MIMO or the MU-MIMO at the UE, where the first indication of MIMO assistance information is transmitted based on the second indication of the completion of the RRC configuration or reconfiguration. In one configuration, the network entity 1102 further includes means for obtaining a third indication of a UE capability for at least one of a separate IC associated with at least one of the SU-MIMO or the MU-MIMO, a separate CSI reporting associated with the SU-MIMO or the MU-MIMO, or a separate SRS transmission associated with the SU-MIMO or the MU-MIMO, where the first indication of MIMO assistance information is transmitted based on the obtaining of the third indication of the UE capability. In one configuration, the network entity 1102 further includes means for transmitting a fourth indication of the MU-MIMO operation to the UE, where the first indication of the MIMO assistance information is transmitted based on receiving the fourth indication of the MU-MIMO operation. In one configuration, the network entity 1102 further includes means for obtaining a request for the MIMO assistance information associated with at least one of the SU-MIMO or the MU-MIMO to the network node based on obtaining the fourth indication of the MU-MIMO operation, where the first indication of the MIMO assistance information is transmitted based on obtaining the request for the MIMO assistance information. The means may be the MU-MIMO assistance information transmitting component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

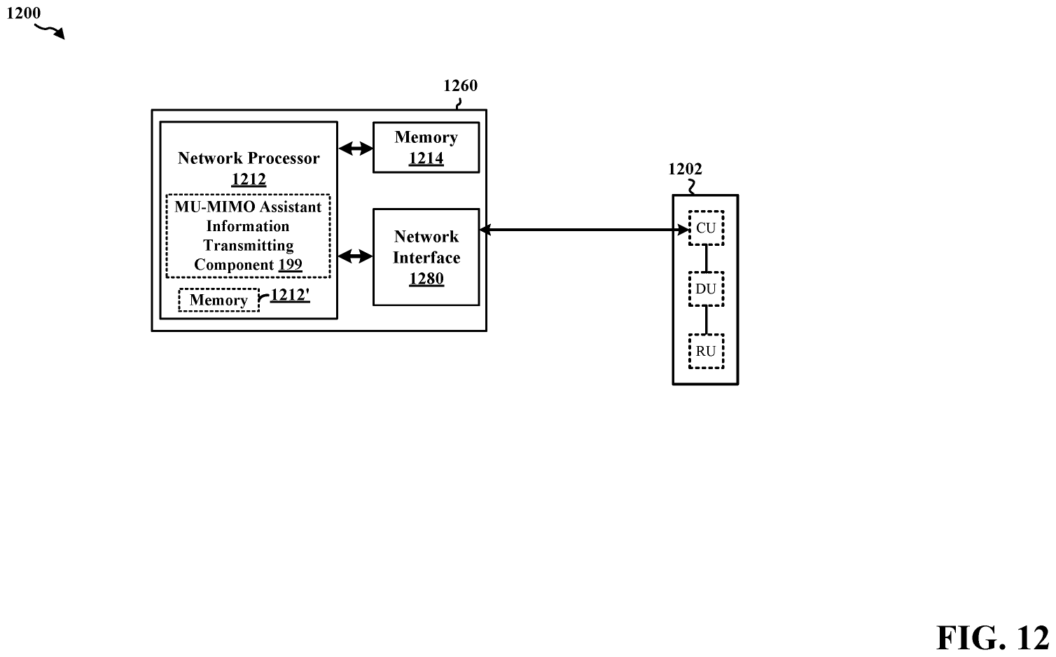

FIG. 12 is a diagram 1200 illustrating an example of a hardware implementation for a network entity 1260. In one example, the network entity 1260 may be within the core network 120. The network entity 1260 may include a network processor 1212. The network processor 1212 may include on-chip memory 1212′. In some aspects, the network entity 1260 may further include additional memory modules 1214. The network entity 1260 communicates via the network interface 1280 directly (e.g., backhaul link) or indirectly (e.g., through a RIC) with the CU 1202. The on-chip memory 1212′ and the additional memory modules 1214 may each be considered a computer-readable medium/memory. Each computer-readable medium/memory may be non-transitory. The processor 1212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the MU-MIMO assistance information transmitting component 199 is configured to transmit a first indication of MIMO assistance information for a UE, where the MIMO assistance information is associated with at least one of a SU-MIMO configuration or a MU-MIMO configuration, and obtain information associated with at least one of a CSI reporting operation or an SRS antenna port switching operation based on at least one of the SU-MIMO configuration or the MU-MIMO configuration. The MU-MIMO assistance information transmitting component 199 may be within the processor 1212. The MU-MIMO assistance information transmitting component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1260 may include a variety of components configured for various functions. In one configuration, the network entity 1260 includes means for transmitting a first indication of MIMO assistance information for a UE, where the MIMO assistance information is associated with at least one of a SU-MIMO configuration or a MU-MIMO configuration, and means for obtaining information associated with at least one of a CSI reporting operation or an SRS antenna port switching operation based on at least one of the SU-MIMO configuration or the MU-MIMO configuration. In one configuration, the MIMO assistance information includes at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration. In one configuration, the first indication of the MIMO assistance information is transmitted via RRC message, DCI, or MAC-CE. In one configuration, the network entity 1260 further includes means for obtaining a confirmation message associated with the MIMO assistance information to the network node, where the confirmation message is obtained after transmitting the first indication of the MIMO assistance information. In one configuration, the network entity 1260 further includes means for transmitting an RRC configuration or reconfiguration associated with at least one of the SU-MIMO or the MU-MIMO, and obtaining a second indication of completion of the RRC configuration or reconfiguration associated with at least one of the SU-MIMO or the MU-MIMO at the UE, where the first indication of MIMO assistance information is transmitted based on the second indication of the completion of the RRC configuration or reconfiguration. In one configuration, the network entity 1260 further includes means for obtaining a third indication of a UE capability for at least one of a separate IC associated with at least one of the SU-MIMO or the MU-MIMO, a separate CSI reporting associated with the SU-MIMO or the MU-MIMO, or a separate SRS transmission associated with the SU-MIMO or the MU-MIMO, where the first indication of MIMO assistance information is transmitted based on the obtaining of the third indication of the UE capability. In one configuration, the network entity 1260 further includes means for transmitting a fourth indication of the MU-MIMO operation to the UE, where the first indication of the MIMO assistance information is transmitted based on receiving the fourth indication of the MU-MIMO operation. In one configuration, the network entity 1260 further includes means for obtaining a request for the MIMO assistance information associated with at least one of the SU-MIMO or the MU-MIMO to the network node based on obtaining the fourth indication of the MU-MIMO operation, where the first indication of the MIMO assistance information is transmitted based on obtaining the request for the MIMO assistance information. The means may be the MU-MIMO assistance information transmitting component 199 of the network entity 1260 configured to perform the functions recited by the means.

According to some aspects of the current disclosure, a UE may be configured to receive a first indication of MIMO assistance information from a network node, where the MIMO assistance information is associated with at least one of a SU-MIMO configuration or a MU-MIMO configuration, perform at least one of an inter-layer IC operation, a CSI reporting operation, or an SRS antenna port switching operation based on at least one of the SU-MIMO configuration or the MU-MIMO configuration, and transmit information associated with at least one of the CSI reporting operation or the SRS antenna port switching operation based on at least one of the SU-MIMO configuration or the MU-MIMO configuration. A network node may be configured to transmit a first indication of MIMO assistance information for a UE, where the MIMO assistance information is associated with at least one of a SU-MIMO configuration or a MU-MIMO configuration, and obtain information associated with at least one of a CSI reporting operation or an SRS antenna port switching operation based on at least one of the SU-MIMO configuration or the MU-MIMO configuration.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving a first indication of MIMO assistance information from a network node, where the MIMO assistance information is associated with at least one of a SU-MIMO configuration or a MU-MIMO configuration, performing at least one of an inter-layer IC operation, a CSI reporting operation, or an SRS antenna port switching operation based on at least one of the SU-MIMO configuration or the MU-MIMO configuration, and transmitting information associated with at least one of the CSI reporting operation or the SRS antenna port switching operation based on at least one of the SU-MIMO configuration or the MU-MIMO configuration.

Aspect 2 is the method of aspect 1, where the MIMO assistance information includes at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration.

Aspect 3 is the method of any of aspects 1 and 2, where the first indication of the MIMO assistance information is received via RRC message, DCI, or MAC-CE.

Aspect 4 is the method of any of aspects 1 to 3, further including transmitting a confirmation message associated with the MIMO assistance information to the network node, where the confirmation message is transmitted after receiving the first indication of the MIMO assistance information.

Aspect 5 is the method of any of aspects 1 to 4, further including receiving an RRC configuration or reconfiguration associated with at least one of the SU-MIMO configuration or the MU-MIMO configuration, and transmitting a second indication of completion of the RRC configuration or reconfiguration associated with at least one of the SU-MIMO configuration or the MU-MIMO configuration at the UE, where the first indication of MIMO assistance information is received based on the second indication of the completion of the RRC configuration or reconfiguration.

Aspect 6 is the method of any of aspects 1 to 5, further including transmitting a third indication of a UE capability for at least one of a separate IC associated with at least one of the SU-MIMO configuration or the MU-MIMO configuration, a separate CSI reporting associated with the SU-MIMO configuration or the MU-MIMO configuration, or a separate SRS transmission associated with the SU-MIMO configuration or the MU-MIMO configuration, where the first indication of MIMO assistance information is received based on the transmission of the third indication of the UE capability.

Aspect 7 is the method of any of aspects 1 to 6, further including receiving a fourth indication of the MU-MIMO operation from the network node, where the first indication of the MIMO assistance information is received based on receiving the fourth indication of the MU-MIMO operation.

Aspect 8 is the method of any of aspects 1 to 7, further including transmitting a request for the MIMO assistance information associated with at least one of the SU-MIMO configuration or the MU-MIMO configuration to the network node based on receiving the fourth indication of the MU-MIMO operation, where the first indication of the MIMO assistance information is received based on transmitting the request for the MIMO assistance information.

Aspect 9 is the method of any of aspects 1 to 8, where the inter-layer IC operation is an intra-UE inter-layer IC operation for the SU-MIMO configuration or an inter-UE inter-layer IC operation for the MU-MIMO configuration.

Aspect 10 is the method of any of aspects 1 to 9, where the CSI reporting operation for the SU-MIMO configuration is different from the CSI reporting operation for the MU-MIMO configuration.

Aspect 11 is the method of any of aspects 1 to 10, where the SRS antenna port switching operation for the SU-MIMO configuration is different from the SRS antenna port switching operation for the MU-MIMO configuration.

Aspect 12 is an apparatus for wireless communication including at least one processor coupled to a memory and configured to implement any of aspects 1 to 11, further including a transceiver coupled to the at least one processor.

Aspect 13 is an apparatus for wireless communication including means for implementing any of aspects 1 to 11.

Aspect 14 is a non-transitory computer-readable medium storing computer executable code, where the code when executed by a processor causes the processor to implement any of aspects 1 to 11.

Aspect 15 is a method of wireless communication at a UE, including transmitting a first indication of MIMO assistance information for a UE, where the MIMO assistance information is associated with at least one of a SU-MIMO configuration or a MU-MIMO configuration, and obtaining information associated with at least one of a CSI reporting operation or an SRS antenna port switching operation based on at least one of the SU-MIMO configuration or the MU-MIMO configuration.

Aspect 16 is the method of aspect 15, where the MIMO assistance information includes at least one of a maximum layer restriction for the MU-MIMO configuration, a separate maximum RI for the SU-MIMO configuration or the MU-MIMO configuration, a number of UEs in a MU-MIMO pair with beam ID and a PMI, an inter-UE spatial correlation, a percentage of overlapped PRBs, a DMRS CDM group usage, or a trigger for the MU-MIMO configuration.

Aspect 17 is the method of any of aspects 15 and 16, where the first indication of the MIMO assistance information is transmitted via an RRC message, DCI, or a MAC-CE.

Aspect 18 is the method of any of aspects 15 to 17, further including obtaining a confirmation message associated with the MIMO assistance information to the network node, where the confirmation message is obtained after transmitting the first indication of the MIMO assistance information.

Aspect 19 is the method of any of aspects 15 to 18, further including transmitting an RRC configuration or reconfiguration associated with at least one of the SU-MIMO configuration or the MU-MIMO configuration, and obtaining a second indication of completion of the RRC configuration or reconfiguration associated with at least one of the SU-MIMO configuration or the MU-MIMO configuration at the UE, where the first indication of MIMO assistance information is transmitted based on the second indication of the completion of the RRC configuration or reconfiguration.

Aspect 20 is the method of any of aspects 15 to 19, further including obtaining a third indication of a UE capability for at least one of a separate IC associated with at least one of the SU-MIMO configuration or the MU-MIMO configuration, a separate CSI reporting associated with the SU-MIMO configuration or the MU-MIMO configuration, or a separate SRS transmission associated with the SU-MIMO configuration or the MU-MIMO configuration, where the first indication of MIMO assistance information is transmitted based on the obtaining of the third indication of the UE capability.

Aspect 21 is the method of any of aspects 15 to 20, further including transmitting a fourth indication of the MU-MIMO operation to the UE, where the first indication of the MIMO assistance information is transmitted based on receiving the fourth indication of the MU-MIMO operation.

Aspect 22 is the method of any of aspects 15 to 21, further including obtaining a request for the MIMO assistance information associated with at least one of the SU-MIMO configuration or the MU-MIMO configuration to the network node based on obtaining the fourth indication of the MU-MIMO operation, where the first indication of the MIMO assistance information is transmitted based on obtaining the request for the MIMO assistance information.

Aspect 23 is an apparatus for wireless communication including at least one processor coupled to a memory and configured to implement any of aspects 15 to 22, further including a transceiver coupled to the at least one processor.

Aspect 24 is an apparatus for wireless communication including means for implementing any of aspects 15 to 22.

Aspect 25 is a non-transitory computer-readable medium storing computer executable code, where the code when executed by a processor causes the processor to implement any of aspects 15 to 22.

What is claimed is:

1. An apparatus for wireless communication at a user equipment (UE), comprising:
a memory; and
at least one processor coupled to the memory and configured to:
receive a first indication of multiple-input multiple-out (MIMO) assistance information from a network node, wherein the MIMO assistance information is associated with at least one of a single-user MIMO (SU-MIMO) configuration or a multiple-user MIMO (MU-MIMO) configuration;
perform at least one of an inter-layer interference cancelation (IC) operation, a channel state information (CSI) reporting operation, or a sounding reference signal (SRS) antenna port switching operation based on at least one of the SU-MIMO configuration or the MU-MIMO configuration; and
transmit information associated with at least one of the CSI reporting operation or the SRS antenna port switching operation based on at least one of the SU-MIMO configuration or the MU-MIMO configuration.

2. The apparatus of claim 1, further comprising a transceiver coupled to the at least one processor,
wherein the MIMO assistance information includes at least one of: a maximum layer restriction for the MU-MIMO configuration, a separate maximum rank indicator (RI) for the SU-MIMO configuration or the MU-MIMO configuration, a number of UEs in a MU-MIMO pair with beam identifier (ID) and a precoding matrix indicator (PMI), an inter-UE spatial correlation, a percentage of overlapped physical resource blocks (PRBs), a demodulation reference signal (DMRS) code division multiplexing (CDM) group usage, or a trigger for the MU-MIMO configuration.

3. The apparatus of claim 1, wherein the first indication of the MIMO assistance information is received via a radio resource control (RRC) message, downlink control information (DCI), or a medium access control (MAC) control element (MAC-CE).

4. The apparatus of claim 1, wherein the at least one processor is further configured to transmit a confirmation message associated with the MIMO assistance information to the network node, wherein the confirmation message is transmitted after receiving the first indication of the MIMO assistance information.

5. The apparatus of claim 1, wherein the at least one processor is further configured to:
receive a radio resource control (RRC) configuration associated with at least one of the SU-MIMO configuration or the MU-MIMO configuration; and
transmit a second indication of completion of the RRC configuration associated with at least one of the SU-MIMO configuration or the MU-MIMO configuration at the UE,
wherein the first indication of MIMO assistance information is received based on the second indication of the completion of the RRC configuration.

6. The apparatus of claim 1, wherein the at least one processor is further configured to transmit a third indication of a UE capability for at least one of: a separate interference cancelation (IC) associated with at least one of the SU-MIMO configuration or the MU-MIMO configuration, a separate CSI reporting associated with the SU-MIMO configuration or the MU-MIMO configuration, or a separate SRS transmission associated with the SU-MIMO configuration or the MU-MIMO configuration,
wherein the first indication of MIMO assistance information is received based on the transmission of the third indication of the UE capability.

7. The apparatus of claim 1, wherein the at least one processor is further configured to receive a fourth indication of the MU-MIMO operation from the network node, wherein the first indication of the MIMO assistance information is received based on receiving the fourth indication of the MU-MIMO operation.

8. The apparatus of claim 7, wherein the at least one processor is further configured to transmit a request for the MIMO assistance information associated with at least one of the SU-MIMO configuration or the MU-MIMO configuration to the network node based on receiving the fourth indication of the MU-MIMO operation, wherein the first indication of the MIMO assistance information is received based on transmitting the request for the MIMO assistance information.

9. The apparatus of claim 1, wherein the inter-layer IC operation is an intra-UE inter-layer IC operation for the SU-MIMO configuration or an inter-UE inter-layer IC operation for the MU-MIMO configuration.

10. The apparatus of claim 1, wherein the CSI reporting operation for the SU-MIMO configuration is different from the CSI reporting operation for the MU-MIMO configuration.

11. The apparatus of claim 1, wherein the SRS antenna port switching operation for the SU-MIMO configuration is different from the SRS antenna port switching operation for the MU-MIMO configuration.

12. An apparatus for wireless communication at a network node, comprising:
a memory; and
at least one processor coupled to the memory and configured to:
transmit a first indication of multiple-input multiple-out (MIMO) assistance information for a user equipment (UE), wherein the MIMO assistance information is associated with at least one of a single-user MIMO (SU-MIMO) configuration or a multiple-user MIMO (MU-MIMO) configuration; and
obtain information associated with at least one of a channel state information (CSI) reporting operation or a sounding reference signal (SRS) antenna port switching operation based on at least one of the SU-MIMO configuration or the MU-MIMO configuration.

13. The apparatus of claim 12, further comprising a transceiver coupled to the at least one processor,
wherein the MIMO assistance information includes at least one of: a maximum layer restriction for the MU-MIMO configuration, a separate maximum rank indicator (RI) for the SU-MIMO configuration or the MU-MIMO configuration, a number of UEs in a MU-MIMO pair with beam identifier (ID) and a precoding matrix indicator (PMI), an inter-UE spatial correlation, a percentage of overlapped physical resource blocks (PRBs), a demodulation reference signal (DMRS) code division multiplexing (CDM) group usage, or a trigger for the MU-MIMO configuration.

14. The apparatus of claim 12, wherein the first indication of the MIMO assistance information is transmitted via a radio resource control (RRC) message, downlink control information (DCI), or a medium access control (MAC) control element (MAC-CE).

15. The apparatus of claim 12, wherein the at least one processor is further configured to obtain a confirmation message associated with the MIMO assistance information to the network node, wherein the confirmation message is obtained after transmitting the first indication of the MIMO assistance information.

16. The apparatus of claim 12, wherein the at least one processor is further configured to:
transmit a radio resource control (RRC) configuration associated with at least one of the SU-MIMO configuration or the MU-MIMO configuration; and
obtain a second indication of completion of the RRC configuration associated with at least one of the SU-MIMO configuration or the MU-MIMO configuration at the UE,
wherein the first indication of MIMO assistance information is transmitted based on the second indication of the completion of the RRC configuration.

17. The apparatus of claim 12, wherein the at least one processor is further configured to obtain a third indication of a UE capability for at least one of: a separate interference cancelation (IC) associated with at least one of the SU-MIMO configuration or the MU-MIMO configuration, a separate CSI reporting associated with the SU-MIMO configuration or the MU-MIMO configuration, or a separate SRS transmission associated with the SU-MIMO configuration or the MU-MIMO configuration,
wherein the first indication of MIMO assistance information is transmitted based on the obtaining of the third indication of the UE capability.

18. The apparatus of claim 12, wherein the at least one processor is further configured to transmit a fourth indication of the MU-MIMO operation to the UE, wherein the first indication of the MIMO assistance information is transmitted based on transmitting the fourth indication of the MU-MIMO operation.

19. The apparatus of claim 18, wherein the at least one processor is further configured to obtain a request for the MIMO assistance information associated with at least one of the SU-MIMO configuration or the MU-MIMO configuration to the network node based on obtaining the fourth indication of the MU-MIMO operation, wherein the first indication of the MIMO assistance information is transmitted based on obtaining the request for the MIMO assistance information.

20. A method of wireless communication at a user equipment (UE), comprising:
receiving a first indication of multiple-input multiple-out (MIMO) assistance information from a network node, wherein the MIMO assistance information is associated with at least one of a single-user MIMO (SU-MIMO) configuration or a multiple-user MIMO (MU-MIMO) configuration;
performing at least one of an inter-layer interference cancelation (IC) operation, a channel state information (CSI) reporting operation, or a sounding reference signal (SRS) antenna port switching operation based on at least one of the SU-MIMO configuration or the MU-MIMO configuration; and
transmitting information associated with at least one of the CSI reporting operation or the SRS antenna port switching operation based on at least one of the SU-MIMO configuration or the MU-MIMO configuration.

21. The method of claim 20, wherein the MIMO assistance information includes at least one of: a maximum layer restriction for the MU-MIMO configuration, a separate maximum rank indicator (RI) for the SU-MIMO configuration or the MU-MIMO configuration, a number of UEs in a MU-MIMO pair with beam identifier (ID) and a precoding matrix indicator (PMI), an inter-UE spatial correlation, a percentage of overlapped physical resource blocks (PRBs), a demodulation reference signal (DMRS) code division multiplexing (CDM) group usage, or a trigger for the MU-MIMO configuration.

22. The method of claim 20, further comprising:
transmitting a confirmation message associated with the MIMO assistance information to the network node, wherein the confirmation message is transmitted after receiving the first indication of the MIMO assistance information.

23. The method of claim 20, further comprising:
receiving a radio resource control (RRC) configuration associated with at least one of the SU-MIMO configuration or the MU-MIMO configuration; and
transmitting a second indication of completion of the RRC configuration associated with at least one of the SU-MIMO configuration or the MU-MIMO configuration at the UE,
wherein the first indication of MIMO assistance information is received based on the second indication of the completion of the RRC configuration.

24. The method of claim 20, further comprising:
transmitting a third indication of a UE capability for at least one of: a separate interference cancelation (IC) associated with at least one of the SU-MIMO configuration or the MU-MIMO configuration, a separate CSI reporting associated with the SU-MIMO configuration or the MU-MIMO configuration, or a separate SRS transmission associated with the SU-MIMO configuration or the MU-MIMO configuration,
wherein the first indication of MIMO assistance information is received based on the transmission of the third indication of the UE capability.

25. The method of claim 20, further comprising:
transmitting a request for the MIMO assistance information associated with at least one of the SU-MIMO configuration or the MU-MIMO configuration to the network node based on receiving a fourth indication of the MU-MIMO operation, wherein the first indication of the MIMO assistance information is received based on transmitting the request for the MIMO assistance information.

26. A method of wireless communication at a network node, comprising:
transmitting a first indication of multiple-input multiple-out (MIMO) assistance information for a user equipment (UE), wherein the MIMO assistance information is associated with at least one of a single-user MIMO (SU-MIMO) configuration or a multiple-user MIMO (MU-MIMO) configuration; and
obtaining information associated with at least one of a channel state information (CSI) reporting operation or a sounding reference signal (SRS) antenna port switching operation based on at least one of the SU-MIMO configuration or the MU-MIMO configuration.

27. The method of claim 26, wherein the MIMO assistance information includes at least one of: a maximum layer restriction for the MU-MIMO configuration, a separate maximum rank indicator (RI) for the SU-MIMO configuration or the MU-MIMO configuration, a number of UEs in a MU-MIMO pair with beam identifier (ID) and a precoding matrix indicator (PMI), an inter-UE spatial correlation, a percentage of overlapped physical resource blocks (PRBs), a demodulation reference signal (DMRS) code division multiplexing (CDM) group usage, or a trigger for the MU-MIMO configuration.

28. The method of claim 26, further comprising:
transmitting a radio resource control (RRC) configuration associated with at least one of the SU-MIMO configuration or the MU-MIMO configuration; and
obtaining a second indication of completion of the RRC configuration associated with at least one of the SU-MIMO configuration or the MU-MIMO configuration at the UE,
wherein the first indication of MIMO assistance information is transmitted based on the first indication of the completion of the RRC configuration.

29. The method of claim 26, further comprising:
obtaining a third indication of a UE capability for at least one of: a separate interference cancelation (IC) associated with at least one of the SU-MIMO configuration or the MU-MIMO configuration, a separate CSI reporting associated with the SU-MIMO configuration or the MU-MIMO configuration, or a separate SRS transmission associated with the SU-MIMO configuration or the MU-MIMO configuration,
wherein the first indication of MIMO assistance information is transmitted based on the obtaining of the third indication of the UE capability.

30. The method of claim 26, further comprising:
obtaining a request for the MIMO assistance information associated with at least one of the SU-MIMO configuration or the MU-MIMO configuration to the network node based on obtaining a fourth indication of the MU-MIMO operation, wherein the first indication of the MIMO assistance information is transmitted based on obtaining the request for the MIMO assistance information.
